(19) United States
(12) Patent Application Publication
(10) Pub. No.: US 2009/0043597 A1
(43) Pub. Date: Feb. 12, 2009

(54) System and method for matching objects using a cluster-dependent multi-armed bandit

(75) Inventors: Deepak Agarwal, San Jose, CA (US); Deepayan Chakrabarti, Mountain View, CA (US); Sandeep Pandey, Santa Clara, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/890,957

(22) Filed: Aug. 7, 2007

(51) Int. Cl. G06Q 30/00

(52) U.S. Cl. 705/1

(57) ABSTRACT

An improved system and method for matching objects using a cluster-dependent multi-armed bandit is provided. The matching may be performed by using a multi-armed bandit where the arms of the bandit may be dependent. In an embodiment, a set of objects segmented into a plurality of clusters of dependent objects may be received, and then a two step policy may be employed by a multi-armed bandit by first running over clusters of arms to select a cluster, and then secondly picking a particular arm inside the selected cluster. The multi-armed bandit may exploit dependencies among the arms to efficiently support exploration of a large number of arms. Various embodiments may include policies for discounted rewards and policies for undiscounted reward. These policies may consider each cluster in isolation during processing, and consequently may dramatically reduce the size of a large state space for finding a solution.

### FIELD OF THE INVENTION

The invention relates generally to computer systems, and more particularly to an improved system and method for matching objects using a cluster-dependent multi-armed bandit.

### BACKGROUND OF THE INVENTION

Selecting advertisements to display on web pages is a common procedure performed in the Internet advertising business. An objective of selecting advertisements to display on web pages is to maximize total revenue from user clicks. Selecting advertisements to display on web pages can be naturally modeled as a multi-armed bandit problem where each advertisement may correspond to an arm, displaying an advertisement may correspond to an arm pull, and user clicks may correspond to the reward received for pulling an arm. The objective of a multi-armed bandit is to pull arms sequentially so as to maximize the total reward, which may correspond to the objective of maximizing total revenue from user clicks in a model for selecting advertisements to display on web pages. Each arm of a multi-armed bandit may have an unknown success probability of emitting a unit reward. The success probabilities of the arms are typically assumed to be independent of each other and it has been shown that the optimal solution to the k-armed problem that maximizes the expected total discounted reward may be obtained by decoupling and solving k independent one-armed problems, dramatically reducing the dimension of the state space. See, for example, J. C. Gittins, Bandit Processes and Dynamic Allocation Indices, Journal of the Royal Statistical Society, Series B, 41, 148-177, 1979, and Frostig, E., & Weiss, G., Four Proofs of Gittins' Multiarmed Bandit Theorem, Applied Probability Trust, 1999.

However, advertisements in online applications may indeed have dependencies and should not be assumed to be independent of each other. For instance, advertisements with similar text are likely to have similar click probabilities in online applications for matching advertisements to content of a web page. Likewise, there may be similar click probabilities in an online auction for search applications where similar advertisers bid on the same keyword or query phrase. In these and other online applications, advertisements with similar text, bidding phrase, and/or advertiser information are likely to have similar click-through probabilities, and this may create dependencies between the arms of a multi-armed bandit used to model such online applications. Other online applications may also be modeled by a multi-armed bandit, such as product recommendations for users visiting an e-commerce website like amazon.com based on visitors' demographics, previous purchase history, etc. In this case, products may be selected to recommend to unique visitors for purchase with an objective of maximizing total sales revenue.

Although treating objects, such as advertisements, as independent of each other may dramatically reduce the dimension of the state space in a multi-armed bandit model by decoupling and solving k independent one-armed problems, assuming independence of advertisements may lead to biased estimates of probabilities of click-through rates (CTRs). In fact, dependencies among advertisements may typically occur and are extremely important for learning CTRs. What is needed is a way to model objects having dependencies using a multi-armed bandit for various online matching applications. Such a system and method should be able to efficiently match a set of objects having dependencies to another set of objects in order to maximize the expected reward accumulated through time.

### SUMMARY OF THE INVENTION

Briefly, the present invention may provide a system and method for matching objects using a cluster-dependent multi-armed bandit. In various embodiments, a server may include an operably coupled cluster-dependent multi-armed bandit that may provide services for matching a set of objects clustered by dependencies to another set of objects in order to determine an overall maximal payoff. The matching engine may include an operably coupled cluster selector for selecting a cluster of dependent objects and may include an operably coupled object selector for selecting an object within that cluster to match to an object of another set of objects in order to determine an overall maximal payoff.

The present invention may provide a framework for matching a set of objects having dependencies to another set of objects in order to maximize the expected reward accumulated through time. The matching may be performed by using a multi-armed bandit where the arms of the bandit may be dependent. In an embodiment, a set of objects segmented into a plurality of clusters of dependent objects may be received, and then a two step policy may be employed by a multi-armed bandit by first running over clusters of arms to select a cluster, and then secondly picking a particular arm inside the selected cluster. The multi-armed bandit may exploit dependencies among the arms to efficiently support exploration of a large number of arms. Various embodiments may include policies for discounted rewards and policies for undiscounted reward. These policies may consider each cluster in isolation during processing, and consequently may dramatically reduce the size of a large state space for finding a solution.

Accordingly, the present invention may be used by online search advertising applications to select advertisements to display on web pages in order to maximize total revenue from user clicks. An online content match advertising applications may use the present invention for matching advertisements to content of a web page in order to maximize total revenue from user clicks. Or online product recommendation applications may use the present invention to select products to recommend to unique visitors for purchase with an objective of maximizing total sales revenue. For any of these online applications, a large set of objects having dependencies may be efficiently matched to another large set of objects in order to maximize the expected reward accumulated through time. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for matching objects belonging to hierarchies, in accordance with an aspect of the present invention;

FIG. 3 is an illustration generally representing the depiction of the evolution from one state to another state of a multi-armed bandit with dependent arms, in accordance with an aspect of the present invention;

FIG. 4 is a flowchart for generally representing the steps undertaken in one embodiment for matching objects using a cluster-dependent multi-armed bandit, in accordance with an aspect of the present invention;

FIG. 5 is a flowchart for generally representing the steps undertaken in one embodiment for matching objects using a cluster-dependent multi-armed bandit with a discounted reward, in accordance with an aspect of the present invention; and

FIG. 6 is a flowchart for generally representing the steps undertaken in one embodiment for matching objects using a cluster-dependent multi-armed bandit with an undiscounted reward, in accordance with an aspect of the present invention.

### DETAILED DESCRIPTION

### Exemplary Operating Environment

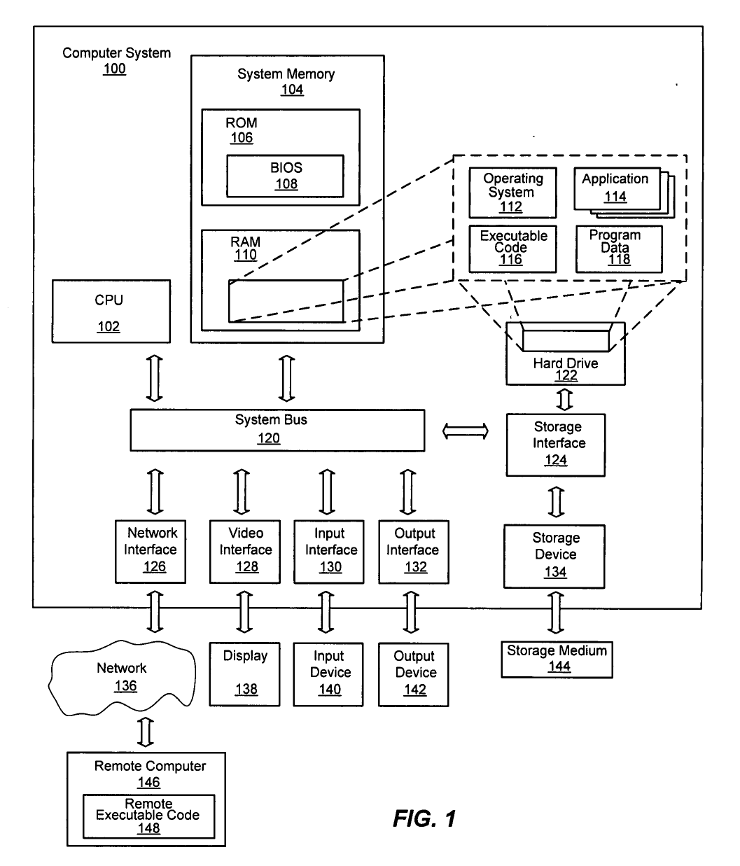

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Matching Objects Using a Cluster-Dependent Multi-Armed Bandit

The present invention is generally directed towards a system and method for matching objects using a cluster-dependent multi-armed bandit. The matching may be performed by using multi-armed bandits where the arms of the bandit may be dependent. As used herein, a dependent multi-armed bandit may mean a multi-armed bandit mechanism with at least two arms that are dependent upon each other. Dependent arms may be grouped into clusters and then a two step policy may be employed by first running over clusters of arms to select a cluster, and then secondly picking a particular arm inside the selected cluster. The cluster-dependent multi-armed bandit may exploit dependencies among the arms to efficiently support exploration of a large number of arms.

As will be seen, the framework of the present invention may be used for many online applications including both online search advertising applications to select advertisements to display on web pages and content match applications for placing advertisements on web pages in order to maximize total revenue from user clicks. As will be understood, the various block diagrams, flow charts and scenarios described herein are only examples, and there are many other scenarios to which the present invention will apply.

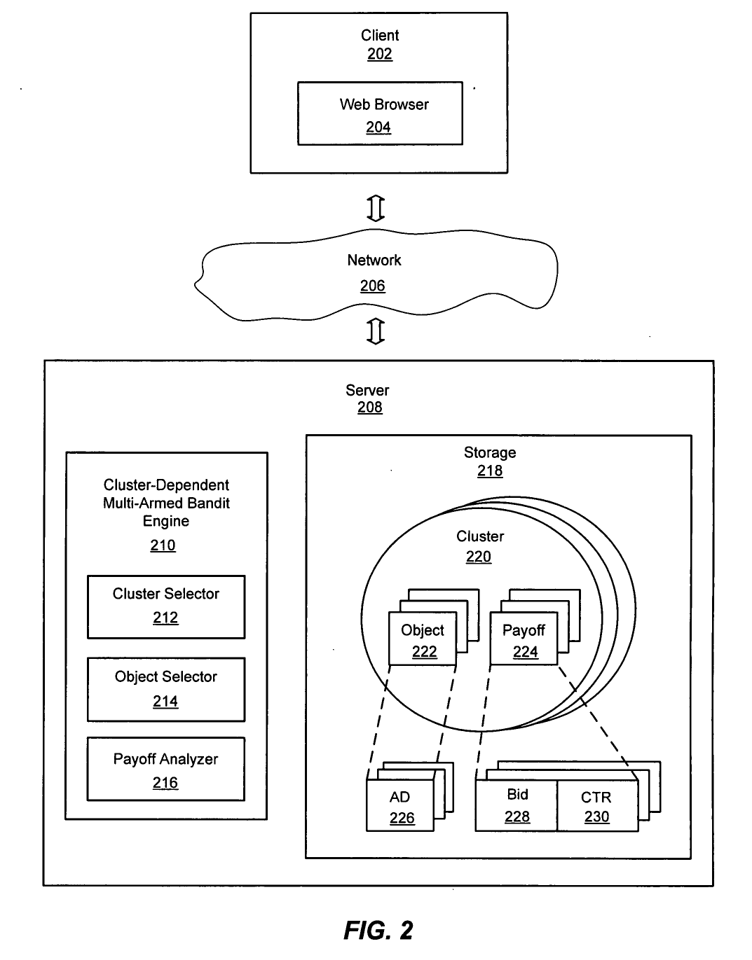

Turning to FIG. 2 of the drawings, there is shown a block diagram generally representing an exemplary architecture of system components for matching objects using a cluster-dependent multi-armed bandit. Those skilled in the art will appreciate that the functionality implemented within the blocks illustrated in the diagram may be implemented as separate components or the functionality of several or all of the blocks may be implemented within a single component. For example, the functionality for the payoff analyzer 216 may be included in the same component as the cluster-dependent multi-armed bandit engine 210. Or the functionality of the payoff analyzer 216 may be implemented as a separate component from the cluster-dependent multi-armed bandit engine 210. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202, and the web browser 204 may include functionality for receiving a query entered by a user and for sending a query request to a server to obtain a list of search results. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide services for query processing and may include services for providing a list of auctioned advertisements to accompany the search results of query processing. In particular, the server 208 may include a cluster-dependent multi-armed bandit engine 210 for choosing advertisements for web page placement locations, a cluster selector 212 for selecting a cluster of objects 222 with associated payoffs 224, an object selector 214 for selecting an object 222 and associated payoff 224 within a cluster 220, and a payoff analyzer 216 for determining the reward for selecting an object 222 in a cluster 220. Each of these modules may also be any type of executable software code such as a kernel component, an application program, a linked library, an object with methods, or other type of executable software code.

The server 208 may be operably coupled to a database of information such as storage 218 that may include clusters 220 of objects 222 with associated payoffs 224. In an embodiment, an object 222 may be an advertisement 226 and a payoff 224 may be represented by a bid 228 and a click-through rate 230. There may be several advertisements 226 representing several bid amounts for various web page placements and the payments for allocating web page placements for bids may be optimized using the cluster-dependent multi-armed bandit engine to select advertisements that may maximize the total revenue to an auctioneer from user clicks.

There are many applications which may use the present invention for efficiently matching a set of objects having dependencies to another set of objects in order to maximize the expected reward accumulated through time. For example, online search advertising applications may use the present invention to select advertisements to display on web pages in order to maximize total revenue from user clicks. An online content match advertising applications may use the present invention for matching advertisements to content of a web page in order to maximize total revenue from user clicks. Or online product recommendation applications may use the present invention to select products to recommend to unique visitors for purchase with an objective of maximizing total sales revenue. For any of these online applications, a set of objects having dependencies may be efficiently matched to another set of objects in order to maximize the expected reward accumulated through time.

In general, the multi-armed bandit is a well studied problem. J. C. Gittins showed the optimal solution to the k-armed problem that maximizes the expected total discounted reward is obtained by decoupling and solving k independent one-armed problems, dramatically reducing the dimension of the state space. See, for example, J. C. Gittins, Bandit Processes and Dynamic Allocation Indices, Journal of the Royal Statistical Society, Series B, 41, 148-177, 1979, and Frostig, E., & Weiss, G., Four Proofs of Gittins' Multiarmed Bandit Theorem, Applied Probability Trust, 1999. In the simplest version of the multi-armed bandit problem, a user must choose at each stage a single bandit/arm to pull. Pulling this bandit will yield a reward which depends on some hidden distribution. The user must then choose whether to exploit the arm currently thought to be the best or to attempt to gather more information about arms that currently appear suboptimal.

Although the multi-armed bandit has been extensively studied, it has generally been studied in the context where the success probabilities of the arms are typically assumed to be independent of each other. Many policies have been proposed for the multi-armed bandit problem under the assumption that the arms are independent of each other. See, for example, Lai, T. L., & Robbins, H., Asymptotically Efficient Adaptive Allocation Rules, Advances in Applied Mathematics, 6, pages 4-22, 1985, and Auer P., Cesa-Bianchi N., & Fischer P., Finite-time Analysis of the Multiarmed Bandit Problem, Machine Learning, 47, pages 235-256, 2002. However, a multi-armed bandit has not been implemented in previous work to exploit dependencies among arms by selecting a cluster followed by an arm in the selected cluster. In the context of an online keyword auction, for instance, to select advertisements for display on web pages, groups of arms/advertisements for similar bidding keywords or phrases may be clustered, and a two-stage allocation rule may be implemented for selecting a cluster followed by an arm in the selected cluster to display an advertisement on a web page.

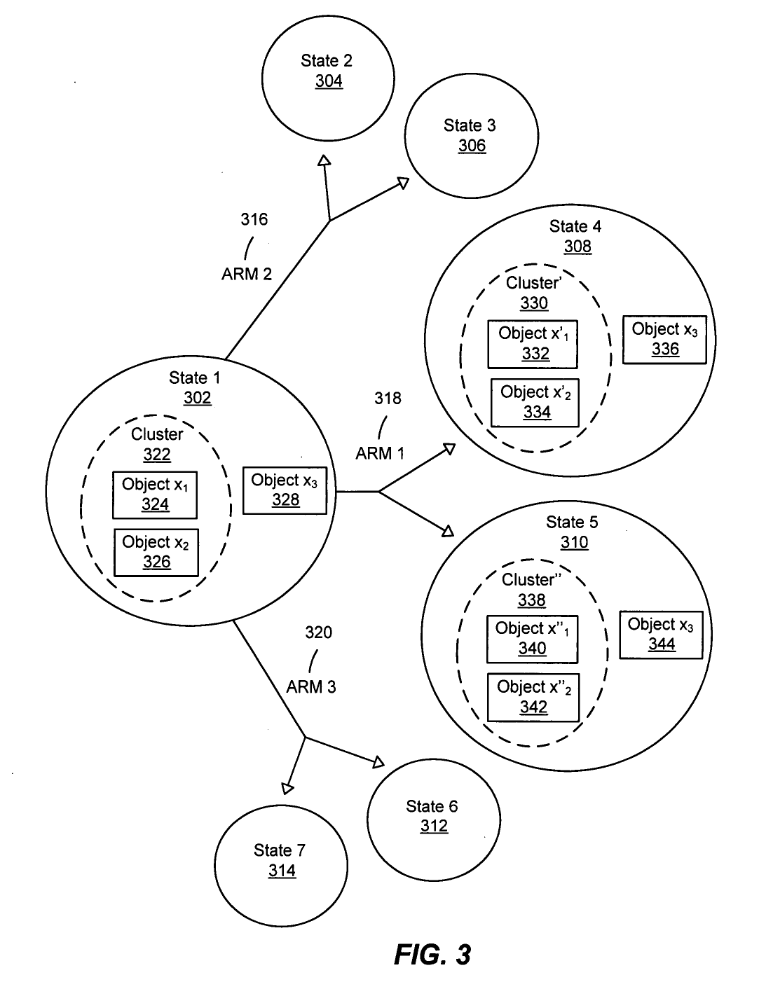

Consider a simple bandit instance as illustrated in FIG. 3 where the arms may be dependent. FIG. 3 presents an illustration generally representing the depiction of the evolution from one state to another state of a multi-armed bandit with dependent arms. In particular, there are seven states illustrated for pulling three arms of a multi-armed bandit. Pulling arm 2 316 indicating sampling object x₂ may result in a transition from state 1 302 to either state 2 304 which may represent a success state or state 3 306 which may represent a failure state. Pulling arm 1 318 indicating sampling object x₁ may result in a transition from state 1 302 to either state 4 308 which may represent a success state or state 5 310 which may represent a failure state. And pulling arm 3 320 indicating sampling object x₃ may result in a transition from state 1 302 to either state 6 312 which may represent a success state or state 7 314 which may represent a failure state.

Assuming success probabilities θ₁ for arm 1, θ₂ for arm 2 and θ₃ for arm 3, there may be a-priori knowledge that |θ₁−θ₂|<0.001. This constraint may induce dependence between arms 1 and 2. For instance, pulling arm 1 for sampling x₁ and pulling arm 2 for sampling x₂ may be treated as a cluster. This may allow the three arm problem to be reduced to a two arm problem where sampling x₁ and sampling x₂ may be treated as a cluster. Thus, state 1 304 may represent object x₃ 328 and cluster 322 that may include dependent objects, object x₁ 324 and object x₂ 326. It may be possible then to construct policies that perform better than those for independent bandits by exploiting the similarity of the first two arms. Pulling arm 1 318 may then represent sampling cluster 322 and may result in transitioning to success state 4 308 with a change in the success probabilities of cluster 322, object x₁324 and x₂ 326 respectively noted by cluster′ 330, object x′₁ 332 and object x′₂ 334. Note that the probability of object x₃ 336 remains unchanged. Or pulling arm 1 318 representing sampling cluster 322 may resulting transitioning to failure state 5 310 with a change in the probabilities of cluster 322, object x₁324 and x₂ 326 respectively noted by cluster″ 330, object x″₁ 332 and object x″₂ 334.

Accordingly, consider a multi-armed bandit with N arms that may be grouped into K clusters. Each arm i may have a fixed but unknown success probability θᵢ. Consider [i] to denote the cluster of arm i. Also consider C_{[i]} to denote the set of all arms in cluster [i] (including i itself), and consider C_{[i]}⁽⁻ⁱ⁾=C_{[i]}\{i}. In each timestep t, one arm i may be chosen (“pulled”), and it may emit a reward R(t) which is 1 with probability θᵢ, and 0 otherwise. The objective is to pull arms so as to maximize the expected discounted reward which may be defined as

$$E [ {Rewards}_{disc} ] = {\sum }_{t = 0}^{∞} {α}^{t} E [ R ( t ) ] ,$$

where 0<α<1 is a discounting factor. Alternatively, the objective may be to pull arms so as to maximize the expected undiscounted finite-time reward which may be defined as

$$E [ {Reward}_{fin} ( T ) ] = {\sum }_{t = 0}^{T} E [ R ( t ) ]$$

for a given time horizon T. Maximizing the objective function may also be equivalent to minimizing the expected regret E[Reg(T)] until time T, where the regret of a policy measures the loss it incurs compared to a policy that may always pull the optimal arm, i.e., the arm with the highest θᵢ.

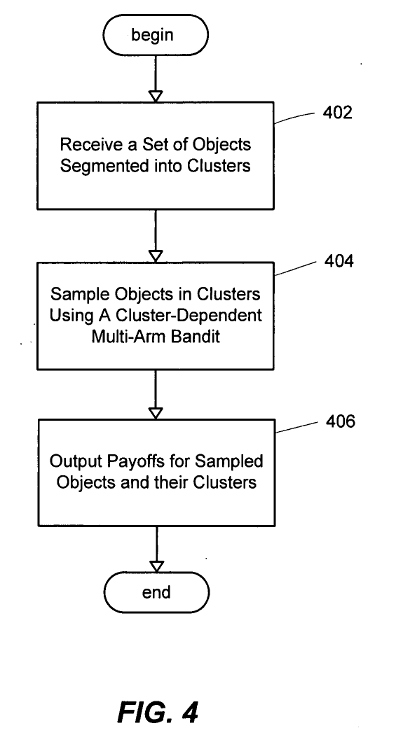

FIG. 4 presents a flowchart for generally representing the steps undertaken in one embodiment for matching objects using a cluster-dependent multi-armed bandit. At step 402, a set of objects segmented into clusters may be received. The objects in a particular cluster may represent objects having dependencies. At step 404, the objects grouped into the clusters may be sampled using a cluster-dependent multi-armed bandit. For example, in an online search advertising applications, the object selected may be an advertisement that may be sample by displaying the advertisement on a web page in order to solicit a user click. If the advertisement receives a user click, then it may receive a reward of one; otherwise, it may receive a reward of zero. At step 406, payoffs for sampled objects and their clusters may be output. In the example of a sampled advertisement in an online search advertising applications, the payoff of the advertisement sampled may be the product of the bid for the advertisement and the click-through rate of the advertisement. In various embodiments, the probabilities for the reward may be updated for each arm and each cluster of the cluster-dependent multi-armed bandit corresponding to the sampled objects.

Assume that the dependencies among arms in a cluster may be described by a generative model with unknown parameters, as follows. Consider sᵢ(t) to denote the number of times arm i generated a unit reward when pulled (“successes”), and fᵢ(t) the number of “failures.” Then, assume that:

sᵢ(t)|θᵢ˜Bin(sᵢ(t)+fᵢ(t),θᵢ), and

θᵢ˜η(π_{[i]}), where η(.) may denote a probability distribution, and π_{[i]} may denote the parameter set for cluster [i]. Intuitively, π_{C} may be considered to abstract out the dependence of arms in cluster C on each other. Thus, given π_{C}, each arm may be considered independent of all other arms.

An equivalent state-space formulation of the dependence of arms in cluster C may be introduced that may useful for deriving an optimal solution for a dependent multi-armed bandit. Associated with each arm i at time t may be a state xᵢ(t) containing sufficient statistics for the posterior distribution of θᵢ given all observations until t: xᵢ(t)=(sᵢ(t), fᵢ(t), π_{[i]}(t)), where π_{[i}](t) is the maximum likelihood estimate of π_{[i]} at time t. If arm i is pulled at time t, it can transition to a “success” state with probability pᵢ(xᵢ(t)) and emit a unit reward, or to a “failure” state and emit a zero reward. In this case, pᵢ(xᵢ(t)) may represent the MAP estimate of θᵢ. Each new observation (success or failure) may change π_{[i]}(t), which simultaneously may change the states for each arm jεC_{[i]}. For arms not in C_{[i]}, the state at t+1 may be identical to that at t. For example, in FIG. 3, pulling arm 1 changes both states of objects x₁ and x₂ due the dependency between the two arms, while leaving object x₃ intact.

Note the difference from the independent multi-armed bandit problem: once an arm i is pulled, the state changes for not only i but also all arms in C_{[i]}⁽⁻ⁱ⁾. Intuitively, the dependencies among arms in a cluster imply that the feedback R(t) for one arm i also provides information about all arms in C_{[i]}⁽⁻ⁱ⁾, thus changing their states.

Typically, algorithms for multi-armed bandit problems may iterate over two general steps, as follows:

In each timestep t:
Apply a bandit policy to choose the next arm to pull; and
Update the parameters of the bandit policy using the result of the arm pull (i.e., reward).

For a multi-armed bandit mechanism with independent arms, the update step needs to look only at the pulls and rewards of each arm in isolation. For a multi-armed bandit mechanism with dependent arms, the update step involves computing π_{[i]}(t) given data on prior arm pulls and corresponding rewards from each cluster; but this is a well-understood statistical procedure. However, incorporating dependence information in the policy step is non-trivial. There may be generally two types of policies to consider for incorporating dependence information: policies for discounted reward and policies for undiscounted reward.

First, an optimal policy may be discussed for dependent bandits with discounted reward:

$$E [ {Reward}_{disc} ] = {\sum }_{t = 0}^{∞} {α}^{t} E [ R ( t ) ] ,$$

where 0<α<1 may be a discounting factor. Every timestep, the optimal policy may compute an (index, arm) pair for each cluster, and then picks the cluster with the highest index and pulls the corresponding arm. Because computing the index exactly may be infeasible, a policy that approximates the optimal policy may be used which may get arbitrarily close to the optimal policy with increasing computing power.

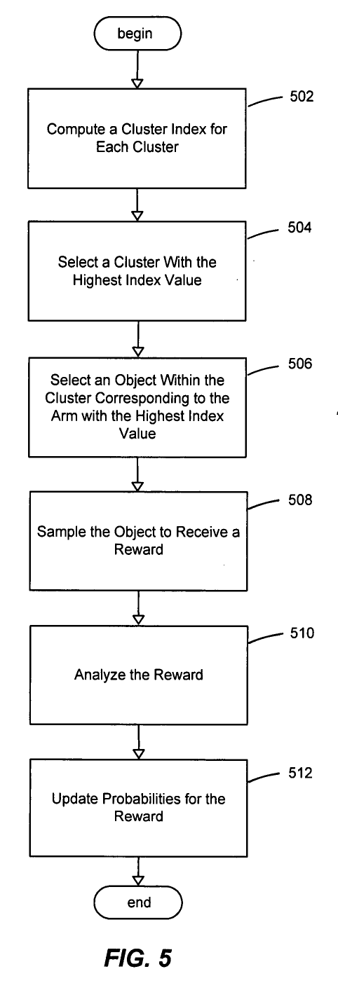

FIG. 5 presents a flowchart for generally representing the steps undertaken in one embodiment for matching objects using a cluster-dependent multi-armed bandit with a discounted reward. A cluster index, representing an index and arm pair, may be computed for each cluster at step 502. In an embodiment, the cluster index may be computed for an individual cluster by estimating a value function using a k-step lookahead of states for arms pulled in that cluster which may maximize the value function. A cluster of objects with the highest index value may be selected at step 504 and an object within the cluster that corresponds to the arm of the highest index value may be selected at step 506.

At step 508, the object selected may be sampled to receive a reward. For example, in an online content match advertising application, the object selected may be an advertisement matched to content of a web page that may be sample by displaying the advertisement on a web page in order to solicit a user click. If the advertisement receives a user click, then it may receive a reward of one; otherwise, it may receive a reward of zero. At step 510, the reward may be analyzed and at step 512 the probabilities for the reward may be updated.

Consider the following dependent multi-armed bandit, M. Every state i may be represented by a vector of the number of successes and failures of all arms. When an arm may be pulled, the corresponding state changes to one of two possible states depending on whether the reward was zero or one, as discussed in the equivalent state-space formulation above. Note that the prior π_{C}(t) can be computed from the state vector itself, and the transition probabilities using π_{C}(t). Using dynamic programming, a value function V(i) may be computed for every state i:

$$V ( i ) = {max}_{1 \leq a \leq N} \{ {\sum }_{j ∈ S ( i , a )} p ( i , j ) \cdot ( R ( i , j ) + α V ( j ) ) \} ,$$

where a may represent any arm that can be pulled, S(i,a) may represent the set of possible states this pull can lead to (i.e., the “success” and “failure” states), and R(i,j) may represent the reward that may be assigned one when j may be reached by a success from i and zero otherwise. The optimal policy for M may select the action (i.e., pulls the arm) that may maximize V(i), which is also the optimal policy for selecting dependent arms grouped in clusters in a dependent multi-armed bandit.

Rather than solve the full dependent multi-armed bandit problem described above, slightly modified dependent multi-armed bandits that may be restricted to the individual clusters may be solved, and the results may be combined to achieve the same optimal policy. In particular, in the restricted dependent multi-armed bandit problem for a cluster c, each state may be allowed to have a “retirement option,” which is a transition to a final rest state with a one-time reward of M (as, for example, in Whittle, P., Multi-armed bandits and the Gittins Index, Journal of the Royal Statistical Society, B, 42, pages 143-149, 1980).

Consider V_{c}(i_{c},M) to denote the value function for the restricted dependent multi-armed bandit problem for cluster c defined as follows:

$${V}_{c} ( {i}_{c} , M ) = max \{ M , {max}_{a ∈ {C}_{c}} {\sum }_{{j}_{c} ∈ S ( {i}_{c} , a )} p ( {i}_{c} , {j}_{c} ) \cdot ( R ( {i}_{c} , {j}_{c} ) + α {V}_{c} ( {j}_{c} , M ) ) \} ,$$

where i_{c} contains only the entries of i belonging to cluster c. Consider a(i_{c},M) to denote the action (possibly retirement) that maximizes V_{c}(i_{c},M), but with ties broken in favor of arm pulls. And consider the cluster index γ_{c} to be defined as γ_{c}=in{M|V_{c}(i_{c},M)=M}.

Assuming the largest cluster index may belong to cluster c*, then the optimal policy at state i for the dependent multi-armed bandit is to choose action a(i_{c}*,γ_{c}*). Note that the optimal action a(i_{c}*,γ_{c}*) may not be the retirement option (which does not exist in the dependent multi-armed bandit), otherwise M may be reduced further in equation γ_{c}=inf{M|V_{c}(i_{c},M)=M}, and γ_{c} would not be the infimum.

Importantly, the optimal policy can be computed by considering each cluster in isolation, instead of all N arms together. Thus, the size of the state space for finding a solution may be reduced from [symbol] ^{N} to [symbol] ^{N}*, where N* may represent the size of the largest cluster. This may advantageously scale for large values of N such as in the millions. Also note that this policy can be expressed in terms of an index γ_{c} on each cluster c, paralleling Gittins' dynamic allocation indices for each arm of an independent bandit (see J. C. Gittins, Bandit Processes and Dynamic Allocation Indices, Journal of the Royal Statistical Society, Series B, 41, 148-177, 1979).

If V_{c}(i_{c},M) could be computed exactly, a binary search on M would give the value of the index γ_{c}. However, the unbounded size of the state space renders exact computation infeasible. Thus an approximation to the optimal policy may be used.

A common method to approximate policies for large dependent multi-armed bandits is to estimate the value function V_{c}(i_{c},M) by a k-step lookahead: given the current state i_{c}, it expands the dependent multi-armed bandit out to a depth of k, assigns to each state j_{c} on the frontier any value \hat{V}_{c}(j_{c},M) between M and max{M,1/(1−α)}, and then computes \hat{V}_{c}(i_{c},M) exactly for this finite dependent multi-armed bandit. The maximum possible reward from any state onwards, without taking the retirement option, may be Σₖ₌₀^{∞}1·α^{k}=1/(1−α), so V_{c}(j_{c},M)≦max{M,1/(1−α)}. Also, V_{c}(j_{c},M)≧M since the retirement option immediately gives that reward. Thus, |\hat{V}_{c}(j_{c},M)−V_{c}(j_{c},M)|≦max{M,1/(1−α)}−M, which translates to a maximum error of δ=α^{k}·(max{M,1/(1−α)}−M) in \hat{V}_{c}(i_{c},M). Note that even though errors may be made on an exponential number of states, their effect on δ is not cumulative; this is because only one best action is chosen for each state by finding a maximum, instead of, say, a weighted sum of these actions. The value of δ also bounds the error of the computed index \hat{γ}_{c} from the optimal. However, this bound may not be tight enough in practice. For example, an application that chooses advertisements to display on web pages from a database of N˜10⁶ advertisements may be expected to converge to the best advertisement in perhaps 10⁷ displays. Equating this with the “effective time horizon” 1/(1−α) yields a discount factor of α=0.9999999, for which the bounds on δ for reasonable values of the lookahead k may not be tight enough. Such problems may occur in even the best known approximations for Gittins' index policy. The independence assumption may break down when observations are few and α>0.95 (See, for example, Chang, F., & Lai, T. L., Optimal Stopping and Dynamic Allocation, Advances in Applied Probability, 19, 829-853, 1987). Such long time horizons may be better handled using an undiscounted reward policy. Indeed, several policies for an undiscounted reward actually approximate the Gittins' index for discounted reward, in the limit of a α→1 (see, for example, Chang, F., & Lai, T. L., Optimal Stopping and Dynamic Allocation, Advances in Applied Probability, 19, 829-853, 1987).

Accordingly, an undiscounted reward may be applied in a policy for selecting dependent arms grouped in clusters in a dependent multi-armed bandit. The generative model for dependence of arms may draw the success probabilities θᵢ, of all arms in a cluster from the same distribution η(.), and if this distribution may be tightly centered around its mean, the θᵢ values may be similar. Thus, the observations from the arms of a cluster may be combined as if they had come from one hypothetical arm representing the entire cluster. This insight may be provided the intuition behind a cluster-dependent policy for a dependent multi-armed bandit: it may use as a subroutine any policy for an independent multi-armed bandit (say, POL), first running POL over clusters of arms to pick a cluster, and then inside that cluster to pick a particular arm.

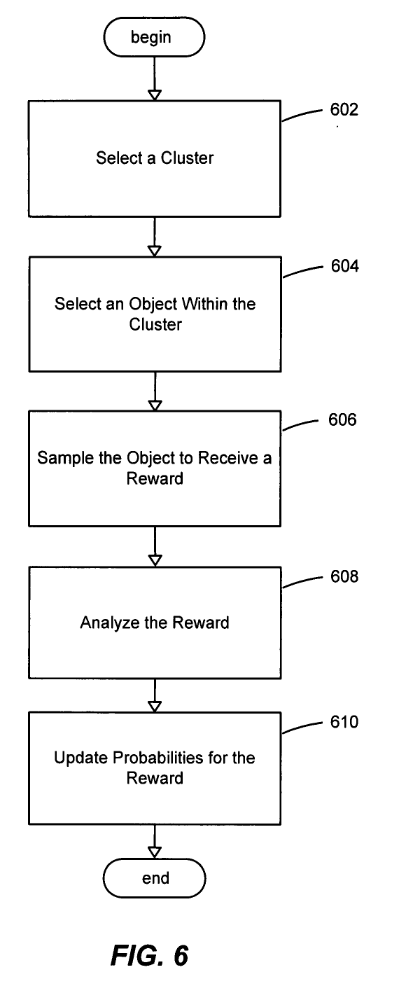

FIG. 6 presents a flowchart for generally representing the steps undertaken in one embodiment for matching objects using a cluster-dependent multi-armed bandit with an undiscounted reward. A cluster of objects may be selected at step 602 based upon a reward estimate \hat{r}ᵢ(t), corresponding to the success probability of the cluster of arms, and a variance estimate \hat{σ}ᵢ(t) of the reward estimate, which can be considered an “equivalent” number of observations from this cluster of arms. Note that this equivalent number of observations need not be the sum of observations from all arms in the cluster. In an embodiment, executable code may be invoked by calling POL(\hat{r}₁(t), \hat{σ}₁(t), . . . , \hat{r}_{K}t, \hat{σ}_{K}(t)) to select a cluster, c(t). Once a cluster of objects may be selected, then an object within the cluster may be selected at step 604 using the mean and variance of the success probability θᵢ of each arm i as its reward and variance estimate.

At step 606, the object selected may be sampled to receive a reward. For example, in an online search advertising applications, the object selected may be an advertisement that may be sample by displaying the advertisement on a web page in order to solicit a user click. If the advertisement receives a user click, then it may receive a reward of one; otherwise, it may receive a reward of zero. At step 608, the reward may be analyzed and at step 610 the probabilities for the reward may be updated. In an embodiment, the probabilities for the reward may be updated by calculating a reward estimate \hat{r}ᵢ(t) and a variance estimate \hat{σ}ᵢ(t) for each cluster i.

The method for matching objects using a cluster-dependent multi-armed bandit may incorporate intra-cluster dependence in two ways. First, by operating on the cluster of arms, it may implicitly group arms of a cluster together. Second, the estimates \hat{r}ᵢ(t) and \hat{σ}ᵢ(t) may be computed based on the observed data and the generative model η(.), if available. Note, however, that even if the form of η(.) is unknown, the method for matching objects using a cluster-dependent multi-armed bandit may still use the fact that the arms are partitioned into clusters, and performs well as a result.

In an embodiment, the policy, POL, may be set to be UCT (see Kocsis, L., & Szepesvari, C., Bandit Based Monte-Carlo Planning, ECML 2006), an extension of UCB1 (See Auer P., Cesa-Bianchi N., & Fischer P., Finite-time Analysis of the Multi-armed Bandit Problem, Machine Learning, 47, 235-256, 2002) that has O(logT) regret. At each timestep, UCT may assign to each arm i a priority pr(i)=sᵢ/(sᵢ+f)ᵢ+Cₚ·\sqrt{(log T)/Tᵢ}, where Cₚ may denote a constant, Tᵢ may represent the number of arm pulls for i, and T=ΣᵢTᵢ. The arm with the highest priority may be pulled at each timestep. UCT reduces to UCB1 when Cₚ=\sqrt{2}.

The method for matching objects using a cluster-dependent multi-armed bandit may allow for several possible forms of \hat{r}ᵢ and \hat{σ}ᵢ. In order to minimize regret, the best arm should be quickly found, and hence the cluster containing that arm. The reward estimate \hat{r}ᵢ should be able to indicate the expected maximum success probability of the arms in the cluster, so that the best cluster is chosen as often as possible. A good reward estimate should be accurate and converge quickly (i.e., \hat{σ}ᵢ→0 quickly). Three such strategies may be used in various embodiments.

In one embodiment, the mean of the success rate of the arms in a cluster may be used to calculate the reward estimate \hat{r}ᵢ. This strategy may be the simplest: when the form of η(.) may be unknown, \hat{r}ᵢ may be assigned the average success rate of arms in the cluster, \hat{r}ᵢ=Σⱼsᵢⱼ/(Σⱼsᵢⱼ+fᵢⱼ) for the arms jεCᵢ, and \hat{σ}ᵢ=(Σⱼsᵢⱼ+fᵢⱼ)·\hat{r}ᵢ·(1−\hat{r}ᵢ) may be assigned the corresponding Binomial variance. When η(.) may be known, the posterior success probabilities and “effective” number of observations for each arm may be used in the above equations. For example, if η˜Beta(a,b), the above equations may use s′ᵢⱼ=sᵢⱼ+a and f′ᵢⱼ=fᵢⱼ+b. However, because the \hat{r}ᵢ of the cluster with the best arm may be dragged down by its suboptimal siblings, the more arms that may be in the cluster, the slower the convergence may be.

In another embodiment, the highest expected success probability E└θⱼ┘ of the arm jεCᵢ in cluster i may be assigned as the reward estimate \hat{r}ᵢ. This strategy may pick from cluster i the arm jεCᵢ with the highest expected success probability E└θⱼ┘, and may set \hat{r}ᵢ and \hat{σ}ᵢ to E└θⱼ┘ and Varθⱼ respectively. Thus, each cluster may be represented by the arm that is currently the best in it. Intuitively, this value should be closer, as compared to the mean, to the maximum success probability of cluster i. Also, \hat{r}ᵢ may not be dragged down by the suboptimal arms of cluster i, reducing the adverse effects of large cluster sizes. However, using the highest expected success probability as the reward estimate may neglect observations from the other arms in the cluster.

In yet another embodiment, the posterior distribution of the maximum success probability among all the arms in Cᵢ, given all observations from the cluster, may be assigned as reward estimate. Where analytic formulas for the posterior are not available, Monte Carlo sampling may be used. These embodiments employing the three strategies cover the spectrum of possibilities, from a simple but biased mean, to the computationally slow posterior distribution of the maximum success probability that gives the most unbiased estimate of the maximum success probability in the cluster.

It is important to note that the performance may depend on the quality of the clustering, such as the “cohesiveness” of the clusters, the separation between clusters, and the sizes of the clusters. Consider i* to denote the best arm from cluster opt. Intuitively, for the cluster-dependent multi-armed bandit to find the best arm, two things should happen: cluster opt should become the top ranked cluster among all clusters, and arm i* should be differentiated from its siblings in opt. Until the first is accomplished, cluster opt will receive only O(logT) pulls and little progress can be made to differentiate arm i* from its siblings in cluster opt. Thus, the effectiveness may depend critically on the “crossover time” T_{c} for cluster opt to finally achieve the highest reward estimate \hat{r}ₒₚₜ(T_{c}) among all clusters, and become the top ranked cluster. In general, as the best cluster becomes more separated from the rest, cluster separation Δ increases and T_{c} may decrease. As the cluster size, Aₒₚₜ, increases, T_{c} may increase. And, high cohesiveness, 1−δₒₚₜ^{avg}, may lead to smaller T_{c}. In fact, when (1−1/Aₒₚₜ)·δₒₚₜ^{avg}<Δ, cluster opt may have the highest reward estimate from the start and T_{c}=0, which may be the best case for example using the mean as the reward estimate. The worst case may occur when the clustering is not good: Δ may be very small and δₒₚₜ^{avg} may be large, implying a large T_{c}.

Thus, the cluster-dependent multi-armed bandit may incorporate dependence information using an undiscounted reward. The policy using an undiscounted reward may provide a tighter bound on error than a policy using a discounted reward. Significantly, both policies may consider each cluster in isolation during processing, instead of considering all N arms together. Accordingly, the size of the state space for finding a solution may be dramatically reduced. This may advantageously scale for large values of N such as in the millions.

As can be seen from the foregoing detailed description, the present invention provides an improved system and method for using a multi-armed bandit with dependent arms clustered to match a set of objects having dependencies to another set of objects. Clustering dependent arms of the multi-armed bandit may support exploration of large number of arms while efficiently supporting short term exploitation. Such a system and method may efficiently be used for many online applications including online search advertising applications to select advertisements to display on web pages, online content match advertising applications to match advertisements to content of a web page, online product recommendation applications to select products to recommend to unique visitors for purchase, and so forth. For any of these online applications, a set of objects having dependencies may be efficiently matched to another set of objects in order to maximize the expected reward accumulated through time. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for matching objects, comprising:
a cluster-dependent multi-armed bandit engine for matching a set of objects clustered by dependencies to another set of objects in order to determine an overall maximal payoff; and
a storage operably coupled to the cluster-dependent multi-armed bandit engine for storing clusters of dependent objects with associated payoffs.

2. The system of claim 1 further comprising a cluster selector operably coupled to the cluster-dependent multi-armed bandit engine for selecting a cluster of dependent objects from the set of objects clustered by dependencies to match to an object of the another set of objects in order to determine an overall maximal payoff.

3. The system of claim 2 further comprising an object selector operably coupled to the cluster-dependent multi-armed bandit engine for selecting an object from the cluster of dependent objects to match to the object of the another set of objects in order to determine an overall maximal payoff.

4. The system of claim 3 further comprising a payoff analyzer operably coupled to the cluster-dependent multi-armed bandit engine for determining the overall maximal payoff for selecting the object from the cluster of dependent objects to match to the object of the another set of objects.

5. A computer-readable medium having computer-executable components comprising the system of claim 1.

6. A computer-implemented method for matching objects, comprising:
receiving a first set of objects segmented into a plurality of clusters of dependent objects;
matching a plurality of objects from the plurality of clusters of dependent objects to a plurality of objects from a second set of objects by sampling the plurality of objects from the plurality of clusters of dependent objects using a multi-armed bandit; and
outputting payoffs for the plurality of objects and the plurality of clusters to which the plurality of objects belong.

7. The method of claim 6 wherein matching the plurality of objects from the plurality of clusters of dependent objects to the plurality of objects from the second set of objects by sampling the plurality of objects from the plurality of clusters of dependent objects using the multi-armed bandit comprises computing a cluster index for each of the plurality of clusters of dependent objects.

8. The method of claim 7 wherein matching the plurality of objects from the plurality of clusters of dependent objects to the plurality of objects from the second set of objects by sampling the plurality of objects from the plurality of clusters of dependent objects using the multi-armed bandit comprises selecting a cluster of dependent objects with a highest index value.

9. The method of claim 8 wherein matching the plurality of objects from the plurality of clusters of dependent objects to the plurality of objects from the second set of objects by sampling the plurality of objects from the plurality of clusters of dependent objects using the multi-armed bandit comprises selecting an object within the cluster of dependent objects corresponding to an arm with the highest index value.

10. The method of claim 9 wherein matching the plurality of objects from the plurality of clusters of dependent objects to the plurality of objects from the second set of objects by sampling the plurality of objects from the plurality of clusters of dependent objects using the multi-armed bandit comprises updating the payoffs for the plurality of objects and the plurality of clusters to which the plurality of objects belong.

11. The method of claim 6 wherein matching the plurality of objects from the plurality of clusters of dependent objects to the plurality of objects from the second set of objects by sampling the plurality of objects from the plurality of clusters of dependent objects using the multi-armed bandit comprises selecting a cluster from the plurality of clusters of dependent objects.

12. The method of claim 11 wherein matching the plurality of objects from the plurality of clusters of dependent objects to the plurality of objects from the second set of objects by sampling the plurality of objects from the plurality of clusters of dependent objects using the multi-armed bandit comprises selecting an object within the cluster from the plurality of clusters of dependent objects.

13. The method of claim 12 wherein matching the plurality of objects from the plurality of clusters of dependent objects to the plurality of objects from the second set of objects by sampling the plurality of objects from the plurality of clusters of dependent objects using the multi-armed bandit comprises sampling the object within the cluster from the plurality of clusters of dependent objects to receive a reward.

14. The method of claim 13 wherein matching the plurality of objects from the plurality of clusters of dependent objects to the plurality of objects from the second set of objects by sampling the plurality of objects from the plurality of clusters of dependent objects using the multi-armed bandit comprises updating a payoff for the object within the cluster from the plurality of clusters of dependent objects and a payoff for the cluster from the plurality of clusters of dependent objects.

15. A computer-readable medium having computer-executable instructions for performing the method of claim 6.

16. A computer system for matching objects, comprising:
means for receiving a first set of objects segmented into a plurality of clusters of dependent objects;
means for matching a plurality of objects from the plurality of clusters of dependent objects to a plurality of objects from a second set of objects by sampling the plurality of objects from the plurality of clusters of dependent objects using a multi-armed bandit; and
means for outputting payoffs for the plurality of objects and the plurality of clusters to which the plurality of objects belong.

17. The computer system of claim 16 wherein means for matching a plurality of objects from the plurality of clusters of dependent objects to a plurality of objects from a second set of objects by sampling the plurality of objects from the plurality of clusters of dependent objects using a multi-armed bandit comprises means for selecting a cluster from the plurality of clusters of dependent objects.

18. The computer system of claim 17 wherein means for matching a plurality of objects from the plurality of clusters of dependent objects to a plurality of objects from a second set of objects by sampling the plurality of objects from the plurality of clusters of dependent objects using a multi-armed bandit comprises means for selecting an object within the cluster from the plurality of clusters of dependent objects.

19. The computer system of claim 18 wherein means for matching a plurality of objects from the plurality of clusters of dependent objects to a plurality of objects from a second set of objects by sampling the plurality of objects from the plurality of clusters of dependent objects using a multi-armed bandit comprises means for updating a payoff for the object within the cluster from the plurality of clusters of dependent objects.

20. The computer system of claim 18 wherein means for matching a plurality of objects from the plurality of clusters of dependent objects to a plurality of objects from a second set of objects by sampling the plurality of objects from the plurality of clusters of dependent objects using a multi-armed bandit comprises means for updating a payoff for the cluster from the plurality of clusters of dependent objects.
